(19) United States
(12) Patent Application Publication
(10) Pub. No.: US 2006/0120781 A1
(43) Pub. Date: Jun. 8, 2006

(54) Registration device, image forming apparatus having the same, and aligning method therefor

(75) Inventors: Dong-Woo Ha, Suwon-si (KR); Jin-ho Park, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/254,863

(22) Filed: Oct. 21, 2005

(30) Foreign Application Priority Data
Dec. 7, 2004 (KR) 2004-0102308

(51) Int. Cl. G03G 15/00

(52) U.S. Cl. 399/395

(57) ABSTRACT

A registration device, an image forming apparatus having the registration device, and a paper registration method are provided. The registration device includes, a registration roller, a registration lever, an actuator, and a returning unit. The registration lever contacts paper when the paper is drawn into the registration roller and moves between an alignment position and an open position. In the alignment position, the registration lever blocks the paper from proceeding further and aligns the paper. In the open position, the paper proceeds past the lever. An actuator selectively allows the registration lever to move from the alignment position to the open position. A returning unit returns the registration lever to an initial position.

### CROSS-REFERENCE TO RELATED APPLICATIONS

This application claims the benefit under 35 U.S.C. § 119(a) of Korean Patent Application No. 10-2004-0102308, filed on Dec. 7, 2004, in the Korean Intellectual Property Office, the entire disclosure of which is hereby incorporated by reference.

### BACKGROUND OF THE INVENTION

1. Field of the Invention

The present invention relates generally to an image forming apparatus. More particularly, the present invention relates to a registration device and method for an image forming apparatus that aligns a front end of paper to prevent the paper from skewing, and an image forming apparatus that uses the registration device.

2. Description of the Related Art

FIG. 1 illustrates a conventional paper alignment method. Referring to FIG. 1, paper P is picked up from a cassette 5 by a pickup roller 1 and then is drawn to a feed roller 3. The paper P may be skewed in the process of being transferred from the cassette 5 to the feed roller 3. To print a high quality image, the paper P must be aligned to prevent the paper from being skewed. A conventional method for aligning the paper will now be described in detail with reference to FIG. 1. The feed roller 3 rotates in a backward direction, which is opposite to a direction in which the paper P is transferred from the cassette 5 to the feed roller 3. When a front end of the paper P reaches the feed roller 3, the paper P is blocked by the feed roller 3 and thus cannot proceed any further. If the feed roller 3 keeps rotating in the backward direction even after the end of the paper P has reached it, the paper P bends, as shown by the dotted lines in FIG. 1, so that the front end of the paper P is aligned with the feed roller 3. Thereafter, the feed roller 3 rotates in a forward direction and thus transfers the paper P to a printing unit 4.

Thus, in the image forming apparatus of FIG. 1, the feed roller 3 serves as a registration roller that aligns paper. As described above, in the conventional paper alignment, paper is aligned by rotating the registration roller in a backward direction and then in a forward direction. This conventional paper alignment method has the following problems, however. First, when the registration roller rotates in a backward direction, the front end of paper is likely to be damaged, and a paper jam is likely to occur. Second, it is not easy to quickly switch the rotation direction of the registration roller from a backward direction to a forward direction because of the rotational inertia of the registration roller, thus increasing loads that a motor (not shown) for driving the registration roller must cope with. Third, as the printing speed of an image forming apparatus increases, it becomes more difficult to rotate the registration roller in a backward direction and then in a forward direction. The difficulties involved in reversing the direction of the roller can be moderated by gradually decreasing the rotation speed of the registration roller in a backward direction until the registration roller completely stops rotating and then gradually increasing the rotation speed of the registration roller in a forward direction. If this is done, however, the printing speed of an image forming apparatus may considerably decrease because of the time required for decelerating and then accelerating the rotation speed of the registration roller.

Accordingly, there is a need for an improved device for registering paper in an image forming apparatus, and an image forming apparatus that uses the improved device.

### SUMMARY OF THE INVENTION

An aspect of the present invention is to address at least the above problems and/or disadvantages and to provide at least the advantages described below. Accordingly, an aspect of the present invention is to provide a registration device and method that help to increase the printing speed of an image forming apparatus, and an image forming apparatus having the registration device.

In an exemplary embodiment of the invention, a registration device for an image forming apparatus includes a registration roller, a registration lever, an actuator, and a returning unit. The registration lever moves between an alignment position and an open position. In the alignment position, the registration lever blocks paper from proceeding further to align the paper. In the open position, the registration lever allows the paper to move past the registration lever. The actuator selectively allows the registration lever to move from the alignment position to the open position, and the returning unit returns the registration lever to an initial position.

In another exemplary embodiment of the invention, an image forming device includes a printing unit that prints images on paper and a registration device that aligns paper which is transferred to the printing unit. The registration device includes a registration roller, a registration lever, an actuator, and a returning unit. The registration lever moves between an alignment position and an open position. In the alignment position, the registration lever blocks paper from proceeding further to align the paper. In the open position, the registration lever allows the paper to move past the registration lever. The actuator selectively allows the registration lever to move from the alignment position to the open position, and the returning unit returns the registration lever to an initial position.

The image forming apparatus may also include a sensor that detects whether the registration lever is in the alignment position.

The registration lever may be rotatably coupled to the registration roller.

The returning unit may include an elastic element, which applies an elastic force to the registration lever in such a direction that returns the registration lever to the initial position.

The returning unit may include an eccentric unit that is moved about a center of rotation of the registration lever and helps the registration lever return to the initial position.

The registration roller may be a feed roller that is located at one side of the printing unit and transfers the paper at predetermined speed.

The image forming apparatus may also include a pickup roller that picks up paper contained in a container and a feed roller that is located at one side of the printing unit and transfers the paper picked up by the pickup roller at predetermined speed. According to an exemplary embodiment, the registration roller is a drive roller located between the pickup roller and the feed roller.

The printing unit may be a shuttle-type inkjet printhead, which prints an image on paper by ejecting ink on the paper while reciprocating in a direction perpendicular to a direction in which the paper is transferred.

The printing unit may be a line-printing inkjet printhead including a nozzle unit whose length substantially corresponds to the width of the paper.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a diagram that illustrates a conventional paper alignment method;

FIG. 2 is a diagram that illustrates an image forming apparatus according to an exemplary embodiment of the present invention;

FIG. 3 is a perspective view of an example of a registration device according to an exemplary embodiment of the present invention;

FIGS. 4A and 4B are cross-sectional views that illustrates an initial position of the registration lever of FIG. 3;

FIGS. 5A and 5B are cross-sectional views that illustrate an example of the registration lever of FIG. 3, which is placed in an alignment position;

FIG. 6 is a cross-sectional view that illustrates another example of the registration lever of FIG. 3, which is placed in an open position;

FIG. 7 is a side view of an example of a returning unit;

FIG. 8 is a side view of another example of the registration device of FIG. 2; and

FIG. 9 is a diagram that illustrates an example of a paper alignment method performed by the image forming apparatus of FIG. 2.

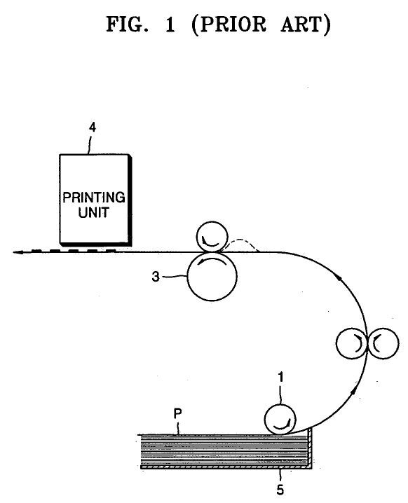

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

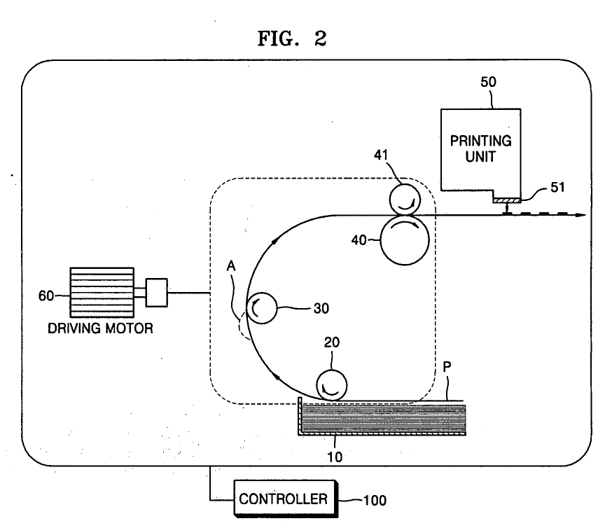

FIG. 2 illustrates an image forming apparatus according to an exemplary embodiment of the present invention. Referring to FIG. 2, the image forming apparatus includes a cassette 10, in which paper P is loaded, a pickup roller 20, which picks up the paper from the cassette 10, and a feed roller 40 and a slave roller 41, which engage with each other and transfer the paper at predetermined speed. The image forming apparatus also includes a drive roller 30, which is located between the pickup roller 20 and the feed roller 40 and assists the transfer of the paper P. Reference numeral 50 is an example of a printing unit that prints an image on the paper P. The printing unit 50 may be a shuttle-type inkjet printhead that prints an image on the paper P by ejecting an ink droplet on the paper P while reciprocating in a direction perpendicular to a direction in which the paper P is transferred. Alternatively, the printing unit 50 may be a line-printing inkjet printhead having a nozzle unit 51 whose length corresponds to the width of the paper P. A driving motor 60 drives the pickup roller 20, the drive roller 30, and the feed roller 40.

The paper P needs to be aligned before reaching the printing unit 50. In order to align the paper P, the image forming apparatus includes a registration device. For example, the drive roller 30 or the feed roller 40 may be used as registration rollers that align the paper P. Alternatively, a registration roller is additionally installed between the pickup roller 20 and the printing unit 50. In the present exemplary embodiment, the drive roller 30 is used as a registration roller and thus, for illustrative purposes, will be referred to as a registration roller 30.

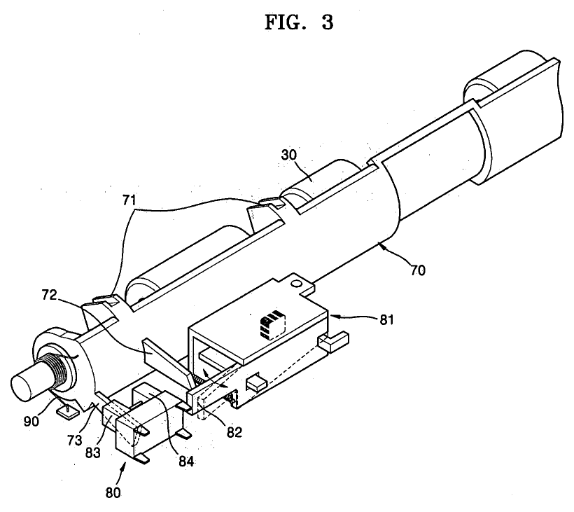

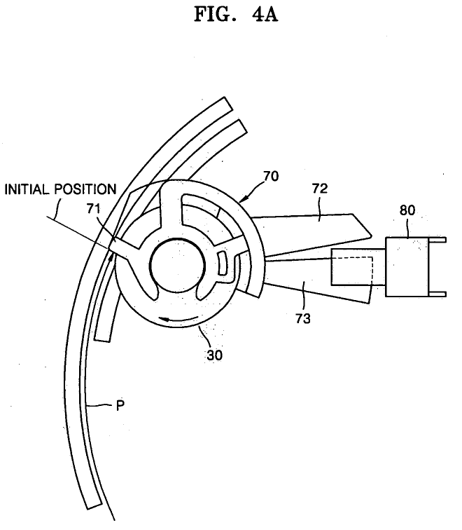

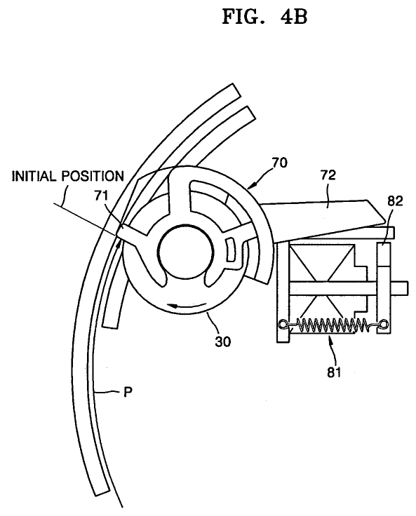

FIG. 3 is a perspective view of an example of a registration device according to an exemplary embodiment of the present invention. Referring to FIG. 3, the registration device includes a registration lever 70, which is shifted between an alignment position and an open position, a solenoid 81, which is an example of actuator and selectively allows the registration lever 70 to be shifted to the open position, and a sensor 80. When in the alignment position, the registration lever 70 stops the paper P from proceeding and aligns the paper P. When in the open position, the registration lever 70 allows the paper P to proceed. The registration lever 70 is coupled to the registration roller 30 to be rotatable. The registration lever 70 includes a contact portion 71, an interference portion 72, and a sensor arm 73. The contact portion 71 is located at one side of the registration roller 30 and comes in contact with a front end of the paper P when the paper P is drawn into the registration device. The interference portion 72 interferes with an arm 82 of the solenoid 81. The registration lever 70 may be selectively allowed to rotate to the open position depending on whether the interference portion 72 interferes with the arm 82 of the solenoid 81. The sensor 80 may be an optical sensor, which includes a light emitter 83 and a light receptor 84, as shown in FIG. 3. Referring to FIG. 4A, when the registration lever 70 is located at an initial position, the sensor arm 73 may be located between the light emitter 83 and the light receptor 84 and thus may block a light path formed therebetween. Referring to FIG. 4B, when the registration lever 70 is located at the initial position, the interference portion 72 is separated from the arm 82 of the solenoid 81. A torsion spring 90 applies an elastic force to the registration lever 70 in such a direction that the registration lever 70 can return to the initial position.

A paper alignment method performed by the image forming apparatus of FIG. 3 will now be described in detail.

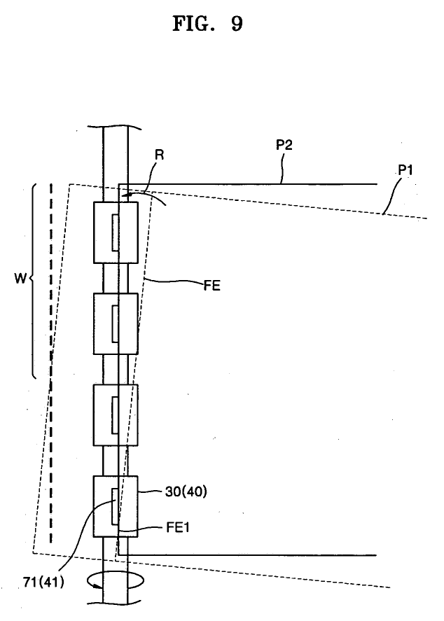

When a print command is input to the controller 100 from a host computer (not shown), the driving motor 60 begins rotating. The pickup roller 20, the registration roller 30, and the feed roller 40 rotate in such a direction that the paper P can be transferred toward the printing unit 50, as shown in FIG. 2. The paper P is picked up from the cassette 20 by the pickup roller 20. The paper P picked up by the pickup roller 20 may be skewed, in which case, a portion FE1 of a front end FE of skewed paper P1 may reach the registration roller 30 first, as shown in FIG. 9. If the skewed paper P1 is transferred toward the printing unit 50 via the feed roller 40 without being appropriately aligned, a paper jam is likely to occur, or a printing error where part of ink ejected from the printing unit 50 fails to arrive at a location where it is supposed to arrive may occur.

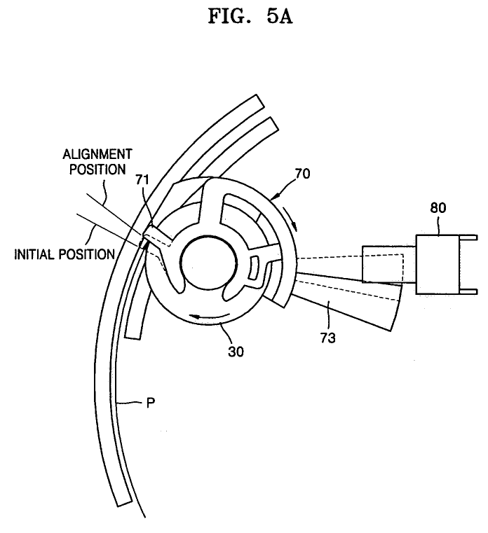

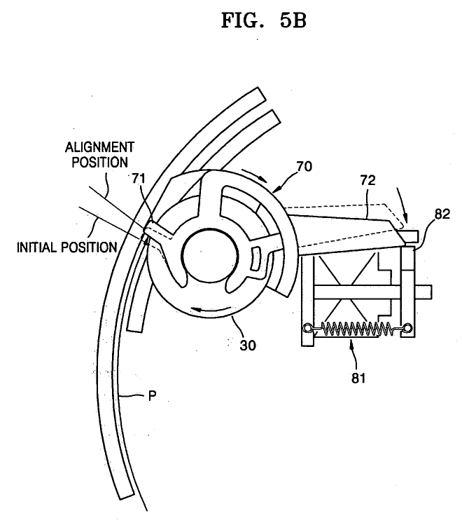

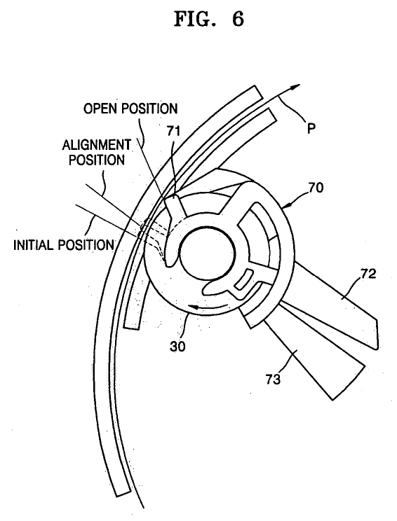

To align the skewed paper P1, the contact portion 71 blocks the end FE of the skewed paper P1 from being drawing into the registration roller 30. When the end FE of the skewed paper P1 comes in contact with the contact portion 71, the registration lever 70 is pushed back by the skewed paper P1 and thus slightly rotated to the open position. As shown in FIG. 5A, the sensor arm 73 opens a light path between the light emitter 83 and the light receptor 84. A signal output from the light receptor 84 is input to the controller 100, and then the controller 100 determines based on the output signal of the light receptor 84 that the registration lever 70 is located at the alignment position. The interference portion 72 cannot rotate any more because it contacts the arm 82 of the solenoid 81. Even if the portion FE1 of the end FE of the skewed paper P1 keeps pushing the contact portion 71 because of the rotation of the pickup roller 20, the registration lever 70 does not rotate any more. Instead, the skewed paper P1 slightly bends, as marked by the dotted line A in FIG. 2, because of its rigidity, and the other end of the skewed paper P1 keeps proceeding until it reaches the contact portion 71. Accordingly, the skewed paper P1 is slightly rotated, as marked by the arrow R of FIG. 9, and thus, the skewed paper P1 is aligned. This paper alignment operation is performed for a predetermined amount of time Tr between the time when the sensor 80 detects that the registration lever 70 is located at the alignment position and the time when the registration lever 70 is allowed to rotate to the open position by the solenoid 81. During the paper alignment operation, the arm 82 of the solenoid 81 contacts the interference portion 72 so that the registration lever 70 is prevented from rotating to the open position. When the paper alignment operation is complete, a current is supplied to the solenoid 81, and the arm 82 is separated from the interference portion 72, as marked by dotted lines of FIG. 3. Since the pickup roller 20 keeps rotating, the aligned paper P2 of FIG. 9 keeps pushing the contact portion 71 so that the registration lever 70 is rotated to the open position. Then, the aligned paper P2 is drawn between the feed roller 40 and the slave roller 41 under the guidance of the registration roller 30. The feed roller 40 transfers the aligned paper P at a predetermined speed, and the printing unit 50 prints an image on the aligned paper P2 by ejecting ink on the aligned paper P2.

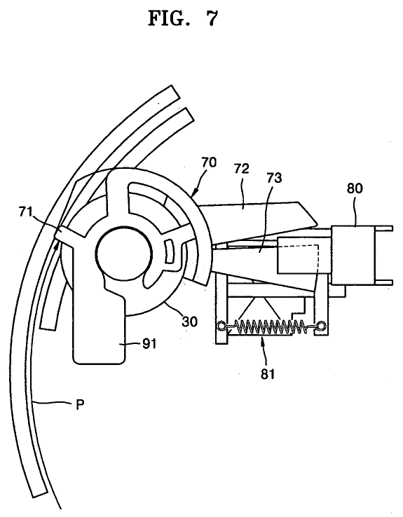

When the other end of the aligned paper P2 passes by the contact portion 71, the registration lever 70 returns to its original location, as shown in FIGS. 4A and 4B, due to an elastic force of the torsion spring 90. Referring to FIG. 7, the registration device according to an exemplary embodiment of the present invention may include an eccentric unit 91, which is dislocated from the center of rotation of the registration lever 70, so as to make the registration lever 70 return from the open position to the alignment position due to gravity.

As described above, the registration roller 30 always rotates in the same direction as the direction in which the paper P is transferred without rotating in the opposite direction or stopping rotating. Accordingly, it is possible to reduce the probability of the end FE of the paper P being damaged by the registration roller 30 and enhance the printing speed of the image forming apparatus. Thus, even when the paper P is transferred at high speed, it is possible to easily align the paper P.

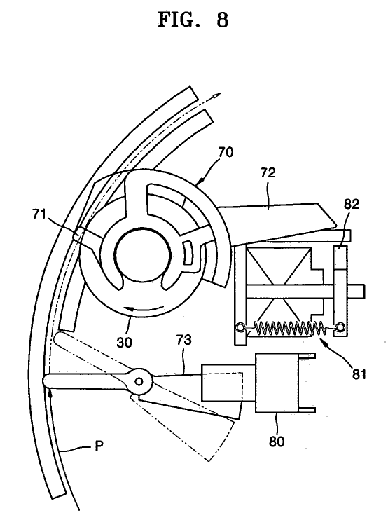

The sensor 80 may detect the end FE of the paper P transferred to the registration roller 30. Referring to FIG. 8, the sensor arm 73 is installed in the registration device and is a spaced predetermined distance apart from the registration roller 30 toward the pickup roller 20. When the paper P rotates the sensor arm 73, the sensor arm 73 opens a light path between the light emitter 83 and the light receptor 84. A signal output from the light receptor 84 is input to the controller 100. An alignment position of the registration lever 70 may be the same as an initial position of the registration lever 70 or may be located between the initial position and an open position of the registration lever 70. If the registration lever 70 is placed in the alignment position, the time To required for rotating the registration lever 70 to the alignment position using the paper P that passes by the sensor arm 73 and then pushes away the contact portion 71 can be calculated using the distance between the sensor arm 73 and the contact portion 71 and the speed of transferring the paper P. After as much time as the sum of To and Tr described above with reference to FIG. 9 has passed, a current is supplied to the solenoid 81, and the registration lever 70 is pushed away by the paper P and thus rotated to the open position. After the other end of the paper P passes by the contact portion 71, the registration lever 70 returns to its original location, as shown in FIGS. 4A and 4B, due to the torsion spring 90 or the eccentric unit 91.

An example of the registration device according to the present invention has been described above as being applicable to an inkjet image forming apparatus but is not restricted to an inkjet image forming apparatus. In other words, the registration device according to the present invention is also applicable to other types of image forming apparatuses, such as electrophotographic printers.

As described above, in the registration device according to an exemplary embodiment of the present invention, a registration roller always rotates in the same direction as a direction in which paper is transferred without rotating in the opposite direction or stopping rotating. Accordingly, it is possible to reduce the probability of an end of the paper being damaged by the registration roller and enhance the printing speed of an image forming apparatus. Thus, even when the paper is transferred at high speed, it is possible to easily align the paper.

While the invention has been shown and described with reference to certain embodiments thereof, it will be understood by those skilled in the art that various changes in form and details may be made therein without departing from the spirit and scope of the invention as defined by the appended claims.

What is claimed is:

1. A registration device for an image forming apparatus comprising:
a registration roller;
a registration lever that contacts a paper when the paper is drawn into the registration roller, the registration lever moving between an alignment position and an open position, the registration lever blocking the paper from proceeding further and aligning the paper when in the alignment position and allowing the paper to proceed further when in the open position;
an actuator that selectively allows the registration lever to move from the alignment position to the open position; and
a returning unit that returns the registration lever to an initial position.

2. The registration device of claim 1 further comprising
a sensor that detects whether the registration lever is in the alignment position.

3. The registration device of claim 1, wherein
the registration lever is rotatably coupled to the registration roller.

4. The registration device of claim 3, wherein the returning unit comprises
an elastic element that applies an elastic force to the registration lever in a direction that returns the registration lever to the initial position.

5. The registration device of claim 3, wherein the returning unit comprises
an eccentric unit that is dislocated from a center of rotation of the registration lever and facilitates the registration lever return to the initial position.

6. The registration device of claim 1 further comprising
a sensor that detects whether the registration lever is in the alignment position, and
wherein the registration lever is rotatably coupled to the registration roller, and the returning unit comprises an elastic element that applies an elastic force to the registration lever in a direction that returns the registration lever to the initial position.

7. The registration device of claim 1 further comprising
a sensor that detects whether the registration lever is in the alignment position, and
wherein the registration lever is rotatably coupled to the registration roller, and the returning unit comprises an eccentric unit that is dislocated from a center of rotation of the registration lever and helps the registration lever return to the initial position.

8. An image forming apparatus comprising:
a printing unit that prints an image on paper; and
a registration device that aligns paper to be transferred to the printing unit, the registration device comprising:
a registration roller;
a registration lever that contacts a paper when the paper is drawn into the registration roller, the registration lever moving between an alignment position and an open position, the registration lever blocking the paper from proceeding further and aligning the paper when in the alignment position and allowing the paper to proceed further when in the open position;
an actuator that selectively allows the registration lever to move from the alignment position to the open position; and
a returning unit that returns the registration lever to an initial position.

9. The image forming apparatus of claim 8 further comprising
a sensor that detects whether the registration lever is in the alignment position.

10. The image forming apparatus of claim 8, wherein
the registration lever is rotatably coupled to the registration roller.

11. The image forming apparatus of claim 10, wherein the returning unit comprises
an elastic element that applies an elastic force to the registration lever in a direction that returns the registration lever to the initial position.

12. The image forming apparatus of claim 10, wherein the returning unit comprises
an eccentric unit that is dislocated from a center of rotation of the registration lever and helps the registration lever return to the initial position.

13. The image forming apparatus of claim 8 further comprising
a sensor that detects whether the registration lever is in the alignment position,
wherein the registration lever is rotatably coupled to the registration roller, and the returning unit comprises an elastic element that applies an elastic force to the registration lever in a direction that returns the registration lever to the initial position.

14. The image forming apparatus of claim 8 further comprising:
a sensor that detects whether the registration lever is in the alignment position, and
wherein the registration lever is rotatably coupled to the registration roller, and the returning unit comprises an eccentric unit that is dislocated from a center of rotation of the registration lever and helps the registration lever return to the initial position.

15. The image forming apparatus of claim 8, wherein
the registration roller is a feed roller that is located at one side of the printing unit and transfers the paper at predetermined speed.

16. The image forming apparatus of claim 8 further comprising:
a pickup roller that picks up paper contained in a container; and
a feed roller that is located at one side of the printing unit and transfers the paper picked up by the pickup roller at predetermined speed,
wherein the registration roller is a drive roller located between the pickup roller and the feed roller.

17. The image forming apparatus of claim 8, wherein
the printing unit is a shuttle-type inkjet printhead that prints an image on the paper by ejecting ink on the paper while reciprocating in a direction perpendicular to a direction in which the paper is transferred.

18. The image forming apparatus of claim 8, wherein
the printing unit is a line-printing inkjet printhead comprising a nozzle unit whose length substantially corresponds to the width of the paper.

19. A method for aligning a sheet of paper in an image forming apparatus comprising a registration roller and a registration lever rotatably coupled to the registration roller so that the registration lever can move between an alignment position that blocks paper from proceeding and an open position that allows paper to proceed, the method comprising the steps of:
placing the registration lever at an initial position;
delivering a sheet of paper to the registration roller, a front end of the sheet of paper contacting the registration lever to move the registration lever to an alignment position so that the movement of the paper is blocked by the registration lever;
continuing to deliver the sheet of paper for a predetermined amount of time to align the sheet of paper;
allowing the registration lever to move from the alignment position to the open position to allow the sheet of paper to proceed past the registration roller.

20. The method of claim 19, further comprising the step of:
returning the registration lever to an initial position after the sheet of paper has passed the registration roller.

21. The method of claim 20, wherein
the step of returning the registration lever to an initial position includes the step of applying an elastic force to the registration lever in a direction that returns the registration lever to the initial position.

22. The method of claim 19, further comprising the step of:
detecting whether the registration lever is in the alignment position.

23. The method of claim 19, wherein
the step of allowing the registration lever to move from the alignment position to the open position comprises the step of actuating an actuator.
